(19) United States
(12) Patent Application Publication
(10) Pub. No.: US 2011/0272515 A1
(43) Pub. Date: Nov. 10, 2011

(54) ROTOR SHREDDER

(75) Inventors: Michael Böhlefeld, Balve-Volkring-Hausen (DE); Udo Becker, Menden (DE)

(73) Assignee: AMNI MASCHINENBAU GMBH, Menden (DE)

(21) Appl. No.: 12/672,947

(22) PCT Filed: Aug. 16, 2008
(86) PCT No.: PCT/EP2008/006740

§ 371 Date: Jul. 26, 2011

(30) Foreign Application Priority Data
Aug. 24, 2007 (DE) 20 2007 011 820.1

(51) Int. Cl. B02C 18/16

(52) U.S. Cl. 241/199.12

(57) ABSTRACT

The invention relates to a rotor shredder, comprising a cutting system frame, made of two lateral walls, which are connected to each other via two end walls in which at least one cutting shaft is rotatably supported, wherein the end walls (12) of the cutting system frame (1) have at least one substantially U-shaped recess (13), receiving the bearings (22) of the at least one cutting shaft (2), wherein the bearings (22) are configured such that they have a substantially U-shaped outer contour, which corresponds to the U-shaped recess (13) of the respectively associated end wall (12).

The invention relates to a rotor shredder according to the generic part of patent claim 1.

Rotor shredders are comminuting machines that work according to the principle of shearing. Such comminuting machines are frequently used for recycling raw materials, and it is a variety of different products such as sheet metal parts, tires or also cooling appliances that can be comminuted using such comminuting machines. Such a pre-known rotor shredder comprises a very sturdy, torsion-resistant cutting system frame with at least one electric motor-driven cutting shaft supported in its end walls. On the cutting shaft a plurality of cutting discs are arranged which regularly carry a plurality of cutting heads. The cutting discs are spaced from each other and cooperate with an additional tool. This additional tool may be a fixed scraper or also a second cutting shaft rotating in the opposite direction of the cutting shaft and carrying cutting discs. The cutting clearance between the cutting discs or also between the cutting disc and the scraper is only a few tenths of millimeters, in order to achieve the desired cutting result. To guarantee the intended rotation of the cutting shafts, wherein the oppositely rotating cutting discs not affect each other, the cutting system frame is designed appropriately sturdy and torsion-resistant, to avoid torsional twisting in the cutting system frame which would change the cutting clearance between the cutting discs even during comminuting very hard or tough material.

In a pre-known rotor shredder, two oppositely driven cutting shafts are provided which are supported in the two mutually opposite end walls of the cutting system frame. The end walls themselves are divided and are formed by a lower end wall element and an upper end wall element. This division is provided for enabling the cutting shaft being lifted off the cutting system frame by removing the upper end wall element. The end wall elements themselves are supported between the end regions of the two opposite lateral walls. The mounting of the end wall elements to the lateral elements takes place by means of fixing screws which penetrate through the lateral walls and laterally engage in the narrow sides of the end wall elements. After screwing the lateral walls together with all of the four end wall elements, the cutting system frame of the pre-known rotor shredder is completed. Adjusting and setting of the cutting system frame required for assuring the intended running of the cutting discs by a corresponding setting of the cutting clearance, takes place via the fixing screws and among others by clamping the lateral elements one against the other.

Due to their wearing, the cutting discs must be exchanged at certain time intervals. To minimize the downtime of such a rotor shredder during an exchange of the cutting discs in the pre-known rotor shredder, the entire cutting shaft is removed from the cutting system frame and replaced by a fresh cutting shaft which is loaded with fresh cutting discs. For this purpose, it is necessary to loosen the fixing screws of the two end wall elements and to completely remove the ones of the upper end wall element to allow its removal from the cutting system frame. But this results in a misalignment of the cutting system frame. Even though it is possible in this type of rotor shredder to exchange a cutting shaft for a fresh cutting shaft within a short time, there is a drawback that each time a cutting shaft is newly installed the cutting system frame must be set and adjusted anew.

From EP 1 099 481 B1 a comminuting machine is known in which the end walls are divided and consist of an upper end wall element and a lower end wall element. The bearings of the cutting shafts are supported by the end wall elements which are designed as yoke plates, one bearing each being framed by the two end wall elements of an end wall. The upper end wall element of each front side of the cutting system frame is detachably mounted to the front sides of the adjacent lateral walls using fixing means, so that the upper end wall elements can be disassembled for allowing the cutting shafts to be removed from the cutting system frame without misalignment of the cutting system frame.

However, this pre-known comminuting machine has the disadvantage that for exchanging the cutting shafts the cutting system frame must be partially disassembled, thus making the exchanging operation complicated. In addition to that, the yoke plates might become canted during mounting, which makes mounting even more difficult.

The invention seeks to remedy this. It is an object of the invention to provide a rotor shredder of the above-described kind enabling an exchange of the cutting shafts without any disassembly of the cutting system frame. According to the invention, this object is achieved by the features of the characterizing part of patent claim 1.

The invention provides a rotor shredder in which exchanging the cutting shafts is possible without any disassembly of the cutting system frame.

According to a further development of the invention, at least one outwardly protruding wing for mounting to the respective end wall is provided laterally on the bearings of the at least one cutting shaft. Easy fixing of the cutting shaft in the cutting system frame is thus possible.

In one arrangement of the invention, a laterally overlapping flange is molded to at least one bearing, which flange can be screwed together with the associated end wall of the cutting system frame on the external side thereof. Thus robust mounting of the bearing to the cutting system frame is achieved.

In a further arrangement of the invention, the at least one laterally outwardly protruding wing is formed by a bridge, of which the outer longitudinal side terminates with the overlapping flange and the inner longitudinal side terminates with the inner side of the end wall. This mainly avoids protruding edges and thus counteracts a possible risk of injury.

Preferably, a nose is molded to the at least one outwardly protruding wing, said nose corresponding with a recess provided next to a substantially U-shaped recess. This facilitates correct positioning of the bearing in the U-shaped recess of the end wall.

Further developments and arrangements of the invention are described in the subclaims. One embodiment of the invention is illustrated in the drawings and will be described in detail in the following. In the drawings it is shown by:

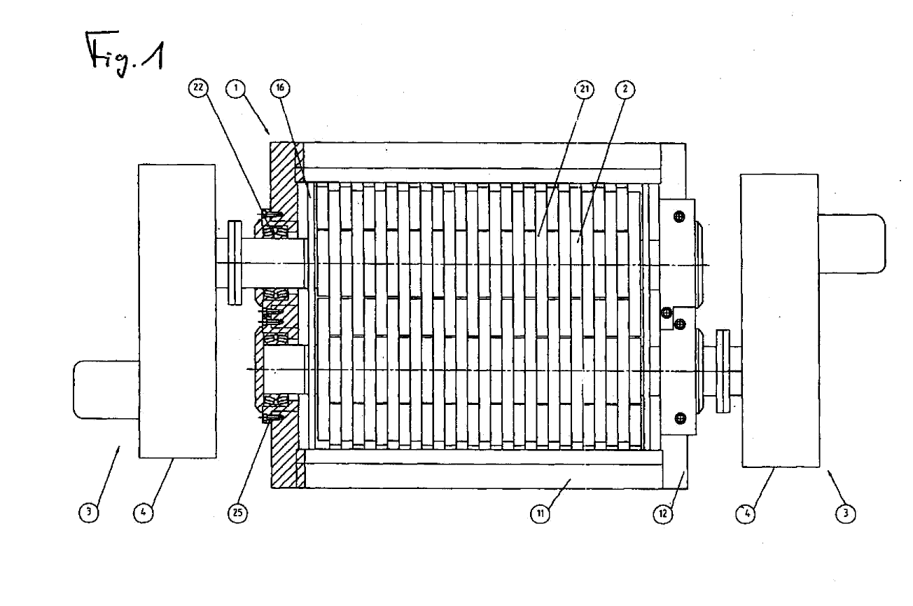

FIG. 1 a partial sectional top view of a rotor shredder comprising two oppositely driven cutting shafts;

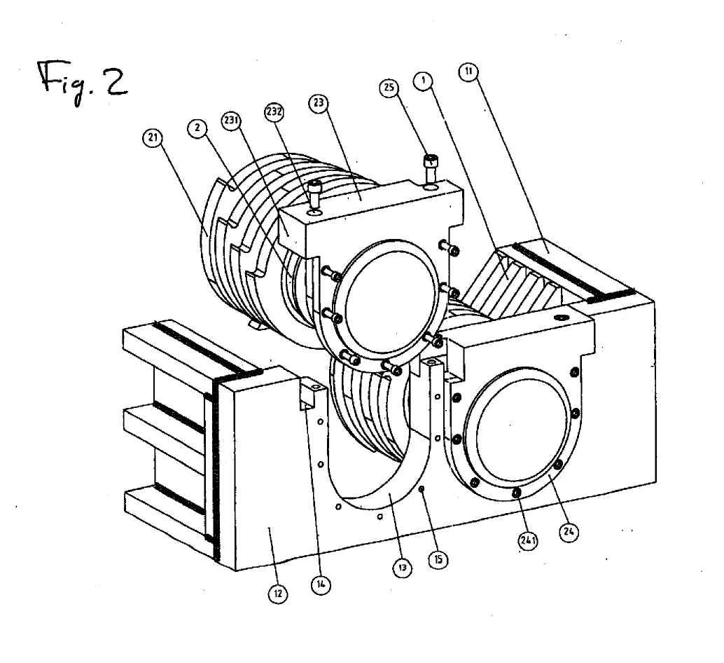

FIG. 2 a three-dimensional representation of the junction between the side wall and the cutting shaft bearing, in a front view; and

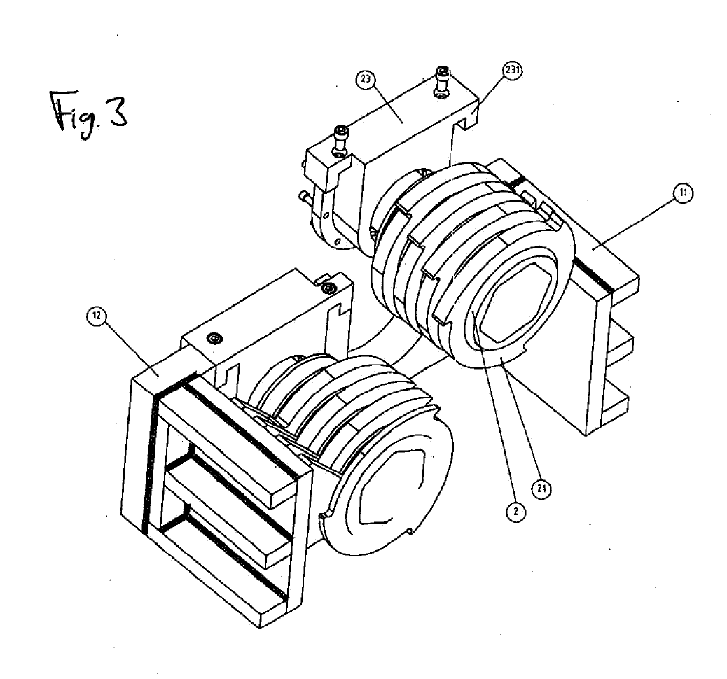

FIG. 3 the representation of FIG. 2, in a rear view.

The rotor shredder, which has been taken as an example, comprises a cutting system frame 1 made of two lateral walls 11 and two end walls 12 connecting the two lateral walls 11 to each other on their front side. Two U-shaped recesses 13 are diametrically arranged next to each other in each of the end walls. The U-shaped recesses 13 serve to receive the bearings 22 of the cutting shaft 2. Next to the recesses 13, on both sides thereof, a respective recess 14 having a substantially rectangular cross section is arranged and spaced from the recesses 13. In addition, the U-shaped recesses 13 are provided with threaded bores 15.

The end walls 12 serve to receive the bearings 22 of two cutting shafts 2, each of which loaded with a plurality of cutting discs 21. The cutting discs 21 of the two cutting shafts 2 are arranged offset to each other and with a cutting clearance of only a few tenths of millimeters between each other.

The bearings 22 of the cutting shafts 2 have a U-shaped outer contour corresponding to the U-shaped recess 13 of the respectively associated end wall 12. Molded to the bearings 12 is a laterally overlapping flange 24 which also has a U-shaped outer contour. Circumferentially of the flange 24 bores 241 are formed which in the mounted condition correspond with the threaded bores 15 of the recess 13 of the end wall 12. The flange 24 joins a bridge 23 terminating with its outer longitudinal side with the flange 24 and with its inner longitudinal side with the inner side of the end wall 12.

The bridge 23 protrudes over the flange 24 on both sides and thus forms protruding wings 231. To the underside of the wings 231 facing the end wall a nose (not illustrated) is molded, corresponding with the respectively associated recess 14 of the end wall 12. Furthermore, a bore 232 is formed in the wings 31 and serves to screw the bridge 23 together with the end wall 12 using screws 25. Mounting of the flange 24 to the end wall 12 also takes place by screwing using screws 25.

The two cutting shafts 2 are driven by driving units 3, which are represented schematically and which are each connected to the cutting shafts 2 via transmission units 4, which are also represented schematically.

On its inner side, each end wall 12 is protected by a wear protection plate 16. The wear protection plates 16 serve to protect both the end walls 12 and the bearings 22 against damage during the operation of the rotor shredder.

The cutting system frame 1 is set and adjusted by screwing the lateral walls 11 together with the end walls 12 at the time of the initial operation of the rotor shredder. It can be seen that the cutting system frame is not disassembled for exchanging the cutting shafts thus excluding a misalignment of the cutting system frame during an exchange of the cutting shafts.

It will become clear from the description of the invention that in the rotor shredder according to the invention the cutting shafts can be exchanged easily and within a short time, which is due to the fixing of the specially designed bearing in the correspondingly formed recess 13 in the end wall 12. Unexpected time losses caused by an adverse effect on the cutting system frame are largely excluded.

1. Rotor shredder, comprising a cutting system frame, made of two lateral walls, which are connected to each other via two end walls in which at least one cutting shaft is rotatably supported, characterized in that the end walls of the cutting system frame have at least one substantially U-shaped recess, receiving the bearings of the at least one cutting shaft, wherein the bearings are configured such that they have a substantially U-shaped outer contour, which corresponds to the U-shaped recess of the respectively associated end wall.

2. Rotor shredder according to claim 1, wherein laterally on the bearings of the at least one cutting shaft at least one outwardly projecting wing is arranged, for mounting to the respective end wall.

3. Rotor shredder according to claim 1, wherein a laterally protruding flange is molded to at least one bearing, which flange contacts the outside of and can be screwed together with the associated end wall of the cutting system frame.

4. Rotor shredder according to claim 3, wherein the at least one outwardly protruding wing is formed by a bridge, the outer longitudinal side of which terminates with the protruding flange and the inner longitudinal side of which terminates with the inner side of the end wall.

5. Rotor shredder according to claim 2, wherein, a nose is molded that to the at least one outwardly protruding wing, said nose corresponding with a recess arranged next to a substantially U-shaped recess.

6. Rotor shredder according to claim 2, wherein that a laterally protruding flange is molded to at least one bearing, which flange contacts the outside of and can be screwed together with the associated end wall of the cutting system frame.

7. Rotor shredder according to claim 3, wherein, a nose is molded that to the at least one outwardly protruding wing, said nose corresponding with a recess arranged next to a substantially U-shaped recess.

8. Rotor shredder according to claim 4, wherein, a nose is molded that to the at least one outwardly protruding wing, said nose corresponding with a recess arranged next to a substantially U-shaped recess.

9. Rotor shredder according to claim 6, wherein, a nose is molded that to the at least one outwardly protruding wing, said nose corresponding with a recess arranged next to a substantially U-shaped recess.
